(19) United States
(12) Patent Application Publication
(10) Pub. No.: US 2016/0222332 A1
(43) Pub. Date: Aug. 4, 2016

(54) METHODS, APPLIANCES, AND SYSTEMS FOR PREPARING A BEVERAGE FROM A BASE LIQUID AND AN INGREDIENT

(71) Applicant: Anheuser-Busch InBev S.A., Belgium (BE)

(72) Inventors: Daniel Peirsman, Bornem (BE); Stijn Vandekerckhove, Sterrebeek (BE); Jerome Pellaud, New Rochelle, NY (US); Nathaniel Davis, New Rochelle, NY (US)

(21) Appl. No.: 15/009,943

(22) Filed: Jan. 29, 2016

Related U.S. Application Data
(60) Provisional application No. 62/110,345, filed on Jan. 30, 2015.

(51) Int. Cl. C12C 11/11; B01F 3/04; B01F 5/02; C12C 5/02

(52) U.S. Cl. CPC C12C 11/11; C12C 5/026; B01F 3/04787; B01F 5/0256; B01F 3/04836

(57) ABSTRACT

The present invention describes methods, systems, and appliances that allow a user to prepare a wide array of different types of customizable beverages using various combinations of base liquids and ingredients. These methods, systems and appliances allow users to design and prepare various types of beverages, both carbonated and non-carbonated, that incorporate various ingredients. These methods, systems, and appliances allow for such beverages to be prepared at varying pressures and temperatures, allowing users to custom-design individual servings of beverages such as beers, wines, ciders, and spirits.

### CROSS-REFERENCE TO RELATED APPLICATION

This application claims the benefit under 35 U.S.C. §119(e) of U.S. Provisional Patent Application No. 62/110,345, filed Jan. 30, 2015, which is herein incorporated by reference in its entirety.

### TECHNICAL FIELD

The present invention pertains to methods, systems, and appliances used to prepare beverages from various mixtures of base liquid(s) and ingredient(s). More particularly, the present invention is directed to: a) methods of preparing a beverage by selecting at least one base liquid and at least one ingredient and mixing the base liquid and ingredient to produce a beverage; b) appliances for preparing a beverage that comprise a liquid inlet for intake of base liquid, a receptacle for intake of an ingredient container, and an outlet for dispensing a beverage mixed from the base liquid and the ingredient contained in the ingredient container; and c) systems for preparing a beverage that comprise a base liquid source, an ingredient source, a mixer for mixing the base liquid with the ingredient to produce a beverage, and a dispenser for dispensing the produced beverage.

### BACKGROUND OF THE INVENTION

In recent years, a diverse array of appliances for preparing and dispensing beverages have been developed and marketed. Some of these methods and appliances allow users to prepare beverages, such as coffee or tea, in single-serving quantities on demand. These appliances vary wildly in their complexity, size, and expense, and can be purchased for use at home or in the office.

Many of these appliances allow users to prepare hot, brewed beverages such as coffee or tea. Commonly, these appliances function by heating water to near-boiling temperatures, and then passing that heated water over coffee powder or tea leaves. In certain appliances, the coffee powder or tea leaves are contained in pre-packaged containers specially designed for use in that appliance. After the coffee or tea is brewed and the beverage dispensed from the machine, a user of the appliance can add ingredients such as milk, cream, sugar, or honey to the beverage.

However, these existing appliances suffer from many drawbacks. They are commonly limited to specific types of hot beverages, such as coffee or tea, as described above. And recently, the beverage world has seen a proliferation of extremely popular custom-flavored beverages—such as microbrewed beers that expertly blend a complex array of flavors and ingredients, spirits infused with fruits and spices, sports drinks that offer both taste and nutrition, and zero-calorie soft drinks that meld new ingredients with traditional flavors. Existing appliances for preparing beverages are simply incapable of meeting the needs and desires for preparing these customizable beverages. For example, there is no existing method, appliance, or system that would allow a user to create, on-demand, a single serving of a beer infused with user-selected flavors and ingredients, carbonated to a user-selected level, and containing the precise amount of alcohol that the user desires.

Thus, there remains a need for methods, systems, and appliances that allow users and consumers to prepare servings of a wide array of customizable beverages on-demand from simple, basic ingredients. The appliances, methods, and systems of the present invention satisfy and fulfill these needs by allowing users to prepare and dispense single servings of custom-designed beverages on demand. By selecting one or more ingredients and combining those one or more ingredients with one (or more) of a number of different base liquids, a user of the present invention can, for example, custom-design single servings of numerous different craft beers from the same beer base liquid. Each of these customized beers can feature its own complex mouth-feel resulting from its user-selected alcohol content, aromas, carbonation level, bitterness, and the other variables that govern the beer's taste. Similarly, a user of the present invention could custom-design single servings of cocktails and other mixed drinks by flavoring base liquid spirits with spices, fruit flavors, and mixers and carbonating the resulting beverage to a user-selected level.

### SUMMARY OF THE INVENTION

The present invention is directed, in certain embodiments, to methods of preparing a beverage, comprising the steps of selecting at least one base liquid, selecting at least one ingredient, mixing the at least one base liquid with the at least one ingredient to produce a beverage, and dispensing the beverage. In certain embodiments of the invention, the at least one base liquid is selected from the group consisting of beers, ciders, wines, malt-based beverages, fermented beverages, cider-based beverages, and spirits. In certain embodiments of the invention, the at least one base liquid is concentrated.

In certain embodiments of the present invention, the at least one base liquid is pressurized. In certain further embodiments of the invention, the pressurized base liquid contains a dissolved gas, wherein the dissolved gas is carbon dioxide, nitrogen, or nitrogen dioxide. In still further embodiments of the invention, the pressurized base liquid has a gas pressure of at least 0.5 bar above atmospheric pressure at 2° C.

In certain embodiments of the present invention, the step of selecting at least one base liquid comprises selecting a first base liquid and selecting a second base liquid. In certain further embodiments of the invention, the second base liquid is selected from the group consisting of beers, juices, syrups, carbonated waters, carbonated soft drinks, alcohols, coffees, teas, milk, and plant extracts. In certain embodiments of the present invention, the step of selecting at least one ingredient comprises selecting a first ingredient and a second ingredient, and the step of mixing comprises mixing the first base liquid with the first ingredient to produce a first mixed liquid, and mixing the second base liquid with the second ingredient to produce a second mixed liquid. In certain further embodiments of the invention, the method for preparing a beverage further comprises the step of jet mixing the first mixed liquid with the second mixed liquid to produce a beverage.

In certain embodiments of the invention, the at least one base liquid is dispensed from a container that is selected from the group consisting of a keg, a bag, a bag-in-bottle, a bag-in-box, a bottle, a can, and a cask. In certain further embodiments of the invention, the base liquid is dispensed from the container using pressurized fluid or a pump.

In certain embodiments of the invention, the at least one ingredient is a flavor ingredient selected from the group consisting of a spice flavor, a fruit flavor, a hop flavor, a malt flavor, a nut flavor, a smoke flavor, a coffee flavor, a chocolate flavor, and mixtures thereof.

In certain embodiments of the invention, the at least one ingredient is a solid or liquid concentrated ingredient selected from the group consisting of hop concentrates, fruit concentrates, sweeteners, bittering additives, concentrated spices, foaming promoters, concentrated malt-based liquids, concentrated fermented liquids, concentrated beer, colorants, alcohols, flavoring additives, and mixtures thereof.

In certain embodiments of the invention, the step of selecting at least one ingredient comprises selecting both a first ingredient and a second ingredient, and the step of mixing comprises mixing the at least one base liquid with the first ingredient to produce a first mixed liquid and mixing the at least one base liquid with the second ingredient to produce a second mixed liquid. In certain further embodiments of the invention, the method for preparing a beverage comprises the step of jet mixing the first mixed liquid with the second mixed liquid to produce the beverage. In still further embodiments of the invention, the second mixed liquid contains a foaming promoter.

In certain embodiments of the invention, the step of mixing the at least one base liquid with the at least one ingredient is performed in a disposable container.

In certain embodiments of the invention, the method for preparing a beverage further comprises the step of expanding a pressurized gas to cool the beverage prior to dispensing the beverage.

In certain embodiments of the invention, the liquid pressure on the at least one base liquid and the beverage are increased during the steps of mixing the at least one base liquid and the at least one ingredient and dispensing the beverage. In certain further embodiments of the invention, the method for preparing a beverage further comprises the step of increasing the pressure after the beverage is dispensed to at least 3 bar above atmospheric pressure.

In certain embodiments of the invention, the method for preparing a beverage further comprises the step of adding pressurized gas to the beverage prior to dispensing the beverage. In certain further embodiments of the invention, the pressurized gas is carbon dioxide, nitrogen, or nitrogen dioxide. In still further embodiments of the invention, the pressurized gas is scented with a flavor selected from the group including fermented hops, a fruit, a herb, a spice, a confectionary, or a mixture thereof.

The present invention is directed, in certain embodiments, to appliances for preparing a beverage, the appliance comprising a first liquid inlet for intake of a first base liquid, a first receptacle for intake of a first ingredient container, a beverage outlet to dispense a mixed beverage, and a first liquid line to transport liquid from the first liquid inlet to the beverage outlet. In certain embodiments of the invention, the appliance for preparing a beverage comprises a second receptacle for intake of a second ingredient container. In certain further embodiments of the invention, the first liquid line is split into a first side line connecting the first liquid line to the first receptacle and a second side line connecting the first liquid inlet to the second receptacle. In still further embodiments of the invention, the first side line connects the first receptacle to the second receptacle.

In certain embodiments of the invention, the appliance for preparing a beverage comprises a microprocessor configured to control a valve capable of varying the flow rate in each of the first side line and the second side line. In certain further embodiments of the invention, the appliance for preparing a beverage comprises a scanner configured to identify the contents of each of the first ingredient container and the second ingredient container. In still further embodiments of the invention, the scanner is coupled to the microprocessor, and the flow rate in each of the first side line and the second side line varies based on the identity of the contents of each of the first ingredient container and the second ingredient container.

In certain embodiments of the invention, the appliance for preparing a beverage comprises a second liquid inlet for intake of a second base liquid and a second liquid line to transport liquid from the second liquid inlet to the beverage outlet. In certain further embodiments of the invention, the first liquid line and the second liquid line are connected to a mixing chamber. In still further embodiments of the invention, the mixing chamber comprises a double jet mixer, the first liquid line is connected to a first jet mixer discharge end, the second liquid line is connected to a second jet mixer discharge end, and the mixing chamber is connected to the beverage outlet via a jet mixer outlet. In still further embodiments of the invention, the double jet mixer is an opposed jet mixer where the first jet mixer discharge end is at a 180 degree angle to the second jet mixer discharge end. In certain other embodiments of the invention, the mixing chamber is directly connected to both the first receptacle and to the second receptacle.

In certain embodiments of the invention, the first liquid line is connected to a mixing chamber. In certain further embodiments of the invention, the mixing chamber is disposable and comprised of a plastic material.

In certain embodiments of the invention, the appliance for preparing a beverage comprises a temperature sensor configured to measure the temperature in the mixing chamber, and a microprocessor connected to the temperature sensor and configured to control the temperature in the mixing chamber based on the measured temperature in the mixing chamber. In certain further embodiments of the invention, the mixing chamber comprises a pressurized fluid inlet, and the pressurized fluid inlet is connected to a source of pressurized fluid. In still further embodiments of the invention, the microprocessor controls the temperature in the mixing chamber by releasing pressurized fluid into the mixing chamber to lower the temperature in the mixing chamber.

In certain embodiments of the invention, the mixing chamber comprises cooling fins extending within the mixing chamber, and the cooling fins are coupled to a heat exchanger configured to remove heat from the cooling fans and out of the mixing chamber.

In certain embodiments of the invention, the appliance for preparing a beverage comprises a pressure regulator configured to control the pressure in the first liquid line. In certain further embodiments of the invention, the pressure regulator is configured to maintain the pressure in the first liquid line at a first pressure level during the dispensing of a mixed beverage and to raise the pressure in the first liquid line to a higher second pressure level once the mixed beverage has been fully dispensed.

In certain embodiments of the invention, the appliance for preparing a beverage comprises a gas ingredient inlet for intake of a first pressurized gas, a pressure chamber within the first liquid line, where the pressure chamber is downstream of the first receptacle and upstream of the beverage outlet, and the pressure chamber is connected to the gas ingredient inlet. In certain further embodiments of the invention, the appliance comprises a measuring appliance configured to measure the amount of dissolved and/or entrained gasses in a mixed beverage, wherein the mixed beverage is located upstream of the pressure chamber. In still further embodiments of the invention, the appliance for preparing a beverage also comprises a jet nozzle in the pressure chamber coupled to the gas ingredient inlet and a microprocessor connected to the measuring appliance, and the microprocessor is configured, depending on the amount of dissolved and/or entrained gasses measured by the measuring appliance, to allow the jet nozzle to sparge pressurized gas in the pressure chamber to raise the gas pressure level in the mixed beverage. In certain further embodiments of the invention, the measuring appliance comprises both an entrained air measurement module and a dissolved air/gas measurement module.

The present invention is directed, in certain embodiments, to systems for preparing a beverage, the systems comprising a base liquid source containing at least one base liquid, an ingredient source containing at least one ingredient, a mixer for mixing the at least one base liquid with the at least one ingredient to produce a beverage, and a dispenser for dispensing the beverage produced from the base liquid and the at least one ingredient. In certain embodiments, the system further comprises a carbonator for carbonating the beverage produced from the base liquid and the at least one ingredient. In some embodiments of the invention, the system comprises a cooling element for lowering the temperature of the beverage produced from the base liquid and the at least one ingredient.

### DETAILED DESCRIPTION OF THE INVENTION

As discussed above, the present invention is directed to methods and appliances used to prepare beverages from various mixtures of base liquid(s) and ingredient(s). In preferred embodiments of the invention, a method for preparing a beverage comprises four steps: a) selecting at least one base liquid; b) selecting at least one ingredient; c) mixing the at least one base liquid with the at least one ingredient to produce a beverage; and d) dispensing the beverage. As those of ordinary skill in the art will recognize, this method allows one to create a vast array of customizable beverages from a simple set of ingredients—allowing the differing tastes of a variety of different users to be met, and permitting users to experiment with designing new beverages and combinations of flavors a single serving at a time.

Various different types of base liquids can be used in the embodiments of the invention. The base liquid can be an alcohol or non-alcoholic liquid, a carbonated or non-carbonated liquid, or various combinations thereof. In some embodiments, an alcoholic liquid can be used as a base liquid, such as a beer (including ales and lagers), a cider, a wine, a malt-based beverage, a fermented beverage, a cider-based beverage, a spirit, and the like. In other embodiments, non-alcoholic versions of these various types of liquids can be used as a base liquid. The base liquid can also be a non-alcoholic liquid such as a beer, a juice, a syrup, a carbonated or non-carbonated water, a carbonated or non-carbonated soft drink, a coffee, a tea, a milk, a plant extract, and the like. Those of skill in the art will also recognize that these various potential base liquids can also be combined and recombinated to form new base liquids.

For the purposes of the present invention, the term “beer” is defined as a beverage produced by the brewing and fermentation of a starch source in water using yeast. Suitable starch sources include, but are not limited to, grains such as barley, wheat, corn, rice, sorghum, and millet. Other starch sources, such as cassava, sugarcane, and potato, can also be used as a starch source to produce a beer. Similarly, various strains of yeast may be used to ferment a “beer,” including but not limited to ale yeast strains (“top-fermenting” yeast) and lager yeast strains (“bottom-fermenting” yeast).

For the purposes of the present invention, the term “beer” includes but is not limited to a particular subset of beverages defined as a “beer” under the definition contained in a particular state's laws, regulations, or standards. For example, the German Reinheitsgebot states that a beverage having ingredients other than water, barley-malt, and hops cannot be considered a “beer”—but for the purposes of the present invention, the term “beer” has no such ingredient restrictions. Similarly, for the purposes of the present invention, the term “beer” does not import or imply a restriction on the alcoholic content of a beverage.

In certain exemplary embodiments, the base liquid is an alcoholic base liquid, such as a beer. The alcoholic base liquid can have an alcohol content of between 0.5 alcohol by volume (ABV) and 12 ABV. In various embodiments of the invention, the alcoholic base liquid can contain between 2-4 ABV, between 4-6 ABV, between 6-8 ABV, between 8-10 ABV, or between 10-12 ABV.

The base liquid can be stored at various temperatures. In exemplary embodiments of the invention, the base liquid is stored at a temperature of below 10° C., below 7.5° C., below 5° C., and/or below 2.5 ° C. In embodiments where the base liquid is an alcoholic base liquid, the base liquid is stored at temperatures below 0° C. and lower, depending on the amount of alcohol in the alcoholic base liquid.

In certain embodiments of the invention, the base liquid is a concentrated base liquid. The base liquid can be concentrated to anywhere from approximately 1.5 times the concentration to approximately 5 times the concentration of the original liquid from which the concentrated base liquid was derived. In one exemplary embodiment, the base liquid is concentrated to approximately 2 times the original concentration of the original liquid from which the base liquid is derived. In another exemplary embodiment, the base liquid is concentrated to approximately 2.5 times the concentration of the original liquid from which it is derived. In yet another exemplary embodiment, the base liquid is concentrated to approximately 3 times the concentration of the original liquid from which it is derived.

In certain embodiments, the concentrated base liquid has a sugar content of between about 30 degrees Brix and about 80 degrees Brix, and more preferably a sugar content of between about 50 degrees Brix and about 70 degrees Brix. In other embodiments of the invention, the concentrated base liquid has a sugar content of between 10 and between 30 degrees Brix.

As those of ordinary skill in the art will recognize, various methods can be used to produce the concentrated base liquid, such as nanofiltration, ultrafiltration, microfiltration, reverse osmosis, distillation, fractionation, carbon filtration, or frame filtration. The concentrated base liquid can be produced using a semi-permeable membrane composed of one or more materials selected from the group consisting of cellulose acetate, polysulfone, polyamide, polypropylene, polylactide, polyethylene terephthalate, zeolites, aluminum, and ceramics.

In a preferred embodiment, the concentrated base liquid is a concentrated beer produced from a high-gravity beer. As those of skill in the art are aware, the “gravity” or “specific gravity” of an alcohol beverage refers to the relative density of the wort (or must, if the beverage is wine) in comparison to water during the fermentation process. The “original gravity” refers to the density of the wort (the sugar-containing liquid extracted from the grain during the mashing process) before yeast is added (or “pitched”) to the wort to begin the fermentation process, where the yeast consumes the sugar in the wort, producing carbon dioxide and alcohol.

For the purposes of the present invention, a “high-gravity” beer refers to a beer having an original gravity of at least 1.070. A higher original gravity indicates that the wort from which the beer is brewed contains a relativity high concentration of sugar and flavor-enhancing ingredients. A higher concentration of sugar provides the yeast more food, from which additional alcohol can be produced, and a high-gravity beer therefore tends to have a higher alcohol content than a beer having a lower original gravity. As those of skill in the art will recognize, different strains of yeast have different tolerances for alcohol, and certain strains may be able to survive at higher alcohol levels than others. In these preferred embodiments, the high gravity beer has an alcohol concentration of at least 8 alcohol by volume (ABV), of at least 12 ABV, or at least 16 ABV.

In certain embodiments of the invention, the base liquid is a pressurized base liquid. The base liquid can be pressurized with the use of a pressurized gas, which dissolves in the base liquid. In certain embodiments of the invention, the pressurized gas has a gas pressure of anywhere from about 0.5 bar overpressure at 2° C. to about 4 bar overpressure at 2° C. In an exemplary embodiment, the pressurized gas has a gas pressure of about 2 bar overpressure at 2° C. In various embodiments of the invention, the pressurized gas can be carbon dioxide, nitrogen, nitrogen dioxide, nitrous oxide, or various combinations thereof.

For purposes of the present invention, a “hypercarbonated” beverage is defined as a beverage that contains a greater amount of dissolved carbon dioxide than the level of carbon dioxide typically found in a carbonated beverage. As a result, a hypercarbonated beverage can be diluted by adding one or more liquids (for example, still water), and result in a beverage having an acceptable level of carbonation. Exemplary embodiments of hypercarbonated beverages include a beer (having a typical carbonation level of 2-6 g/L of carbon dioxide when carbonated) carbonated to a level greater than 6 grams of carbon dioxide per liter, or a water or soft drink (having a typical carbonation level of 4-7 g/L when carbonated) carbonated to a level greater than 7 grams of carbon dioxide per liter. In some preferred embodiments of the present invention, the base liquid is a hypercarbonated beverage.

In the same manner that numerous different base liquids can be used in the methods and appliances of the present invention, those of ordinary skill in the art will recognize that various types of ingredients can be used in the present invention. In some embodiments of the invention, the ingredient added to the beverage comprises one or more solid or liquid flavor ingredients that can be added to the concentrated beverage to produce a final beverage. Examples of suitable flavor ingredients include (but are not limited to) a spice flavor, a fruit flavor, an herb flavor, a hop flavor, a malt flavor, a nut flavor, a smoke flavor, other suitable flavors (such as a coffee flavor or a chocolate flavor), and mixtures of such flavors.

In other embodiments of the present invention, the ingredient added to the concentrated beverage comprises one or more solid or liquid concentrated ingredients. In various embodiments of the present invention, the potential concentrated ingredients are selected from the group consisting of hop concentrates, fruit concentrates, sweeteners, bittering additives, concentrated spices, foaming promoters, concentrated malt-based liquids, concentrated fermented liquids, concentrated beer, colorants, flavor additives and mixtures thereof In some cases, the concentrated ingredients (for example, concentrated beers) may be alcoholic concentrated ingredients.

Those of ordinary skill in the art will recognize that various methods can be used to produce the various types of concentrated ingredients, such as nanofiltration, ultrafiltration, microfiltration, reverse osmosis, distillation, fractionation, carbon filtration, or frame filtration, using the variety of semi-permeable membrane materials described above in reference to the production of a concentrated base liquid. The concentrated ingredient may be the permeate or the retentate of a concentration process, and may be produced by repeating one or more concentration processes and combining the permeates and retentates from those processes. The concentrated ingredient may contain water, alcohol, volatile flavor components, amino acids, aromatic substances, monovalent salts, carbohydrates, proteins, and/or divalent and multivalent salts.

In certain embodiments of the invention, a user wishing to prepare a beverage can select two or more different base liquids for the beverage. In an exemplary embodiment, a first base liquid is an alcoholic liquid such as a beer (including ales and lagers), a cider, a wine, a malt-based beverage, a fermented beverage, a cider-based beverage, or a spirit, and the second base liquid is a beer, a juice, a syrup, a carbonated or non-carbonated water, a carbonated or non-carbonated soft drink, a coffee, a tea, a milk, and/or a plant extract.

If two or more different base liquids are used to prepare a beverage, a first ingredient can be mixed with the first base liquid to produce a first mixed liquid, and a second ingredient can be mixed with the second base liquid to produce a second mixed liquid. The first mixed liquid can then be mixed with the second mixed liquid to produce the beverage.

In exemplary embodiments of the invention, the first mixed liquid and the second mixed liquid are mixed together via jet mixing, but those of ordinary skill in the art will recognize that other methods of mixing (i.e., electro-mechanical means such as blades or propellers) can be used as well. For example, in other exemplary embodiments of the invention, the first and second mixed liquids can be mixed together with a static mixer, without moving parts, that utilizes turbulence to mix liquids and produce a beverage. The static mixer can be composed of various materials, including stainless steel, polypropylene, Teflon, PDVF, PVC, CPVC, and polyacetal, and can be a plate-type static mixer or a helical-type static mixer. In some embodiments of the invention, the mixing chamber is a disposable plastic mixer chamber which can be disposed and replaced for sanitary reasons.

In certain embodiments of the present invention, the static mixer is an in-line mixer. In some embodiments of the invention, this mixing element is a venturi (a constricted, narrow diameter section of a pipe or line, which causes liquid passing through that section to increase in velocity but decrease in pressure—a phenomenon known as the “venturi effect”). As liquid flows through the venturi, the venturi effect creates a vacuum which causes turbulence, causing mixing of the liquid(s) and other ingredients to occur.

Those of ordinary skill will also recognize that a third base liquid can be mixed with a third ingredient, a fourth base liquid can be mixed with a fourth ingredient, and so forth.

In certain exemplary embodiments of the invention, the first base liquid is a concentrated base liquid, and the second base liquid is a carbonated or non-carbonated water. In these embodiments, the water dilutes the concentrated first base liquid (which may also be carbonated or non-carbonated) so that the sugar content of a serving of the diluted liquid is equivalent to the sugar content of the beverage from which the concentrated first base liquid was derived. In some embodiments, the alcohol content of the diluted liquid is equivalent to the alcohol content of the beverage from which the concentrated first base liquid was derived. In other embodiments, a concentrated ingredient that contains alcohol can be added to the diluted liquid to raise its alcohol content to a desired level.

In other embodiments of the invention, a single base liquid can be combined with multiple ingredients to prepare a beverage. For example, a first base liquid could be combined with a first ingredient to produce a first mixed liquid, and that same second base liquid can be combined with a second ingredient to produce a second mixed liquid. These first and second mixed liquids may then be mixed together to prepare a beverage using mixing methods known to those of skill in the art (such as jet mixing, as described above). Alternatively, the first mixed liquid could be combined with the second ingredient to produce the beverage.

In embodiments of the invention where a first mixed liquid is mixed with a second mixed liquid to produce a beverage, the second mixed liquid may contain a foaming promoter. Suitable promoters comprise, for example, proteins and glycoproteins from flaked wheat, flaked barley, wheat malt, and/or barley malt. These foaming promoters result in a beverage being dispensed that has improved foaming properties, resulting in a desirable foam collar atop a dispensed beverage. In certain embodiments of the invention, the first mixed liquid may contain a first colorant, and the second mixed liquid may contain a second colorant, allowing beverages to be dispensed with different layers of color (or combinations of color if the liquids are mixed together). As one of ordinary skill in the art would recognizes, adding more mixed liquids containing colorants will result in a beverage containing even more layers of color.

In embodiments of the present invention, the one or more base liquids may be contained in and dispensed from one or more containers. These containers may be a keg, a bag, a bottle, a can, a cask, and other equivalent containers. In an exemplary embodiment, the container is a “bag-in-bottle” container composed of an inner, collapsible bladder or bag (the “bag”) containing the liquid to be dispensed, where that inner “bag” is itself contained within an outer, rigid container (the “bottle”). Similarly, in other exemplary embodiments, the container is a “bag-in-box” container comprising the same inner, collapsible “bag” as the exemplary “bag-in-bottle” containers, but also comprising an outer, rigid “box” in which the bag is contained instead of a rounded “bottle.” In other embodiments, other types of “container-in-container” devices can be utilized as the container.

The container containing the base liquid may be comprised of various materials, including, for example, metals like steel and aluminum, plastics such as polyethylene terephthalate (PET) or high-density polyethylene (HDPE), glass, or polymers such as rubber. In certain embodiments—for example, the “bag-in-bottle” and “bag-in-box” containers described above—different components of the container are each comprised of different materials depending on the particular function of those components.

In certain embodiments of the invention, the container in which the base liquid is contained is pressurized and contains pressurized fluid. This pressurized fluid can drive the base liquid out of the container during preparation of a beverage. In other embodiments of the invention, the base liquid container may utilize a pumping appliance to drive base liquid from the container, or use pressurized fluid contained in separate containers (such as bottles) to drive base liquid from the container. In other embodiments, the container may simply use gravity to drive base liquid from the container.

In an exemplary embodiment, the container is a bag-in-bottle container (as described above), and the base liquid contained within the bag is driven out of the container by injecting and pumping pressurized fluid, for example atmospheric air, into a void between the bag and the rigid bottle containing the bag. As fluid fills this void, it exerts pressure on the liquid in the bag, forcing it out of the container. In this exemplary embodiment, a user can control how much base liquid is released from the container (and, therefore, how much base liquid is used to produce a beverage). In some exemplary embodiments, the amount of liquid driven from the bag-in-bottle container can be pre-programmed or automatically determined based on the particular ingredient(s) with which the base liquid is to be mixed. In another exemplary embodiment, the container is a bag-in-box container, and the base liquid contained within the bag is driven out of the container by injecting pressurized fluid into a void between the bag and the rigid box containing the bag.

In certain embodiments of the invention, the one or more ingredients are provided in one or more containers. These containers may be a pod, a capsule, a pack, a bottle, a cylinder, and a cartridge, and may be composed of various materials, such as metal, aluminum, plastic, or polymer. In exemplary embodiments of the invention, the container is a reusable container. In certain embodiments of the invention, the reusable container can be re-filled with additional ingredients. In certain other embodiments of the invention, the reusable container may contain enough ingredient for multiple servings of beverages, and can be used multiple times with the same (or a different) base liquid to dispense multiple drinks.

In various embodiments of the invention, the serving size of the beverage produced can be 6 ounces, 8 ounces, 10 ounces, 12 ounces, 14 ounces, 16 ounces, 18 ounces, 20 ounces, 22 ounces, or 24 ounces, and each container of ingredient contains between about 5, 6, 7, 8, 9, 10, 11 or 12 grams and about 15 grams of the ingredient. In an exemplary embodiment of the invention, the beverage produced from the base liquid and the ingredient is a 12 ounce beverage containing 8 grams of ingredient.

In certain exemplary embodiments of the invention, the ingredient container is a disposable container comprised of plastic, which is thrown away or recycled after it is used to prepare and dispense a beverage. In certain embodiments, the ingredient container can be used to prepare and dispense multiple beverages, but is disposed of once no more ingredient remains in the container.

In various embodiments of the invention, the ingredient container may have properties intended to preserve the ingredients stored within the container. In some embodiments, the ingredient container may comprise oxygen scavengers or oxygen absorbers, such as ferrous carbonate, ascorbate, sodium hydrogen carbonate, and citrus, which reduce the level of oxygen in the package, preventing at least some oxidation reactions from occurring and helping to preserve the ingredients in the container. In some embodiments of the invention, the ingredient container may be a gas barrier, an oxygen barrier, and/or a light barrier. For example, the exterior of the container may be coated with an inorganic oxide, which helps prevent gases such as oxygen and carbon dioxide from entering or exiting the container, and a light blocking colorant, to help prevent light (including ultraviolet light) that can cause chemical reactions with the ingredients from entering the container.

In some embodiments of the invention, the container also contains a volume of compressed, pressurized gas. The gas may be pressurized to a level of about 0.5 bars above atmospheric pressure to about 2.0 bars above atmospheric pressure. In certain further embodiments of the invention, the pressurized gas is located in a first chamber of the ingredient container, and the ingredient is located in a second chamber of the ingredient container. When the ingredient is mixed with the base liquid, the pressurized gas escapes from the container, expanding and acting to cool the mixture of the concentrated ingredient and the base liquid.

One of skill in the art will recognize that other means can be utilized to cool the beverage produced from the base liquid(s) and ingredient(s), and that the beverage can be dispensed at various temperatures. In a preferred embodiment, the beverage is an alcohol beverage dispensed at a temperature equal to or below 0° C., equal to or below 2° C., or equal to or below 5° C.

As those of ordinary skill in the art will recognize, during the process of mixing a one or more base liquid with one or more ingredients, the gas pressure of the base liquid (and the amount of dissolved gas contained within the liquid) may decrease. In some cases, this may be due to gas scavenging properties of the ingredient. Therefore, in certain embodiments of the invention, after the one or more base liquids are mixed with the one or more ingredients to prepare a beverage, pressurized gas is added to the beverage before the beverage is dispensed. In certain embodiments, this additional pressurized gas compensates for any loss of dissolved gas that occurs from mixing. In other embodiments, the pressurized gas is added to further pressurize the beverage (resulting, for example, in a hypercarbonated beverage being dispensed).

In certain embodiments of the invention, the additional pressurized gas to be added to the beverage is carbon dioxide, nitrogen, nitrogen dioxide, and/or nitrous oxide. In some embodiments, the pressurized gas can be provided from a vessel containing the pressurized gas. In other embodiments, the pressurized gas is generated from a solid or liquid source, for example effervescent or chemical reactants such as food-grade carbonates or acids that are capable of generating carbon dioxide when introduced to water.

In certain exemplary embodiments of the invention, the pressurized gas to be added to the beverage, before the beverage is dispensed, is scented. The pressurized gas may be scented with a flavor such as fermented hops, fruit(s), herb(s), spice(s), confectionaries, mixtures thereof, or other suitable flavors known to those of skill in the art.

Certain exemplary embodiments of the present invention are directed to appliances for preparing beverages from one or more base liquids and one or more ingredients. The size and shape of these appliances vary, but in certain exemplary embodiments, the appliance is capable of fitting on a home countertop or table—having a height no greater than 0.5 meters and a footprint of no greater than 0.25 square meters.

In exemplary embodiments of the present invention, an appliance for preparing a beverage includes at least a first liquid inlet for intake of a first base liquid, at least a first receptacle for intake of a first ingredient container, a beverage outlet for dispensing a mixed beverage, and at least a first liquid line capable of transporting liquid from the first liquid inlet through the appliance to the beverage outlet, where a beverage is ultimately dispensed. The appliance generally also includes a housing containing the functional components of the appliance. In certain embodiments of the invention, at least a portion of the housing is transparent, allowing a user to view the components of the appliance located within the housing.

In certain embodiments, the first liquid inlet may be a pipe fitting suitable for connecting directly to a base liquid container, or it may be the inlet of a pipe or flexible tube or hose that is connected to the base liquid container. It will be apparent to those of skill in the art that the appliances of the present invention are not limited to a single base liquid, but may contain two or more liquid inlets.

In embodiments of the present invention, the receptacle for intake of a first ingredient container is capable of receiving a specific type of ingredient container. In other embodiments, the receptacle is capable of receiving multiple types of ingredient containers. As discussed above, these ingredient containers may take various forms, such as a pod, a capsule, a pack, a bottle, a cylinder, and a cartridge, and may be composed of varying materials.

As one of skill in the art would recognize, appliances according to the present invention are not limited to a single receptacle for intake of an ingredient container, but may contain two or more receptacles for intake of ingredient containers. In certain embodiments, each receptacle may be designed to receive the same type of ingredient containers, but in other embodiments, different receptacles are capable of receiving different types of containers.

In exemplary embodiments of the present invention, the appliance for preparing a beverage contains a first liquid line which connects the liquid inlet (the location where base liquid is input into the appliance) with the contents of the ingredient containers input into the one or more receptacles, and ultimately to the beverage outlet where a beverage is ultimately dispensed. In certain embodiments, this liquid line may connect one or more liquid inlets with one or more ingredient containers, allowing multiple base liquids to be combined with multiple ingredients at one time so that customized and complex beverages can be prepared and dispensed.

### Exemplary Embodiment Capable of Combining Multiple Concentrated Ingredients With a Base Liquid

In one exemplary embodiment of the present invention, an appliance for preparing beverages includes two separate receptacles for intake of ingredient containers. In this exemplary embodiment, the liquid line is connected at one end to a first liquid inlet for intake of base liquid into the appliance.

In this exemplary two-receptacle embodiment, the liquid line splits into first and second side liquid lines downstream of the liquid inlet. The first side line liquid line connects to a first one of the two receptacles, and the second side liquid line connects to a second one of the two receptacles. These connections allow the base liquid to be mixed with the ingredients contained within the containers located within each of the receptacles. In this exemplary embodiment, the two side liquid lines intersect and join together again into a single liquid line—at this intersection point, the mixed liquids contained in each of the side liquid lines are mixed together. In some embodiments, this intersection point is downstream of both receptacles (a so-called “in parallel” embodiment). In other embodiments, this intersection occurs at the second receptacle—downstream of the first receptacle (a so-called “in series” embodiment, which allows the ingredient in the second receptacle to be mixed with a greater volume of liquid than the first receptacle). This single liquid line then connects to the beverage outlet, allowing the now-mixed beverage to be dispensed from the appliance. As one of ordinary skill would recognize, this exemplary two-receptacle embodiment could be adapted to appliances with three (or more) receptacles and a corresponding number of side liquid lines.

In some embodiments of the invention, the mixing of the base liquid and the ingredient occurs within the ingredient containers themselves. If the ingredient containers are reusable, they can be removed from the appliance and washed before re-use. In certain other embodiments, the containers are disposable, and are thrown away or recycled after one or more uses (depending on the amount of ingredient contained in the container). In certain exemplary embodiments, these disposable containers are plastic containers which are transparent or translucent, allowing a user of the appliance to watch as the base liquid mixes with the contents of the ingredient container.

In the exemplary two-receptacle embodiment described above, the beverage dispensing appliance includes one or more valves that are configured to control the rate of liquid flow through the liquid line and the two side liquid lines. As those of ordinary skill in the art will recognize, the two ingredient containers may contain different ingredients, as well as different volumes of those ingredients. These ingredients may each have different mixing behavior, different solubility in the base liquid(s), and/or different viscosities (some ingredients are liquid, others solid). Additionally, these ingredients will affect the temperature of the base liquid, which may be carefully controlled in certain embodiments, in varying degrees. Therefore, the one or more valves described above allow the rate and amount of base liquid mixed with these ingredients to be controlled, depending on the identity and volume of the ingredient contained in each of the two ingredient containers.

In certain exemplary embodiments of the appliance, each ingredient container is marked with an identity tag, such as (but not limited to) a bar code or an RFID tag. In certain embodiments of the invention, the appliance includes a scanner (such as a bar code or RFID scanner) capable of reading the identity tag and determining the type and volume of ingredient in a particular container. In other embodiments, the type and/or volume of ingredient can be manually input by a user of the appliance.

In these certain embodiments of the invention, the appliance also includes a controller for controlling the one or more valves which regulate the flow rate of base liquid through the side liquid lines, and a microprocessor and memory connected to that controller. Suitable controllers, valves, and microprocessors will be known to those skilled in the art. The memory contains a set of pre-loaded “dispensing sequences” for setting and varying the position of these one or more valves during the preparation of the beverage, and the microprocessor selects one of these dispensing sequences depending on the type and volume of ingredient in a container. In some embodiments, users of the appliance can manually select or program their own dispensing sequences.

In certain exemplary embodiments of the invention, the controller may allow base liquid only to flow through the first side line for a period of time, then allow base liquid to only flow through the second side line for a period of time. This exemplary “dispensing sequence” could produce various results: for instance, if the second ingredient contained a foaming promoter, this sequence would result in a beverage where the foam was dispensed in a collar on top of the beverage. And if each container contained a different colorant, this exemplary dispensing sequence would result in a beverage in which different colors were layered on top of each other.

In addition to controlling the flow rate of base liquid through each of the two side liquid lines, in certain embodiments, the flow rate of base liquid through the liquid inlet itself into the liquid line can be controlled as well. This control can be accomplished with a choking appliance which reduces or expands an area through which base liquid flows in order to set a desired flow rate. This choking appliance can be controlled by a same or similar controller as the controller of the one or more valves that adjust the flow rate through the side liquid lines.

A common concern about beverage dispensing appliances containing liquid supply lines is the buildup of biofilm in the liquid supply lines. This biofilm raises hygienic/sanitary concerns and can negatively affect the taste of prepared beverages. To alleviate this problem, in certain embodiments of the invention, a first level of pressure, higher than ambient pressure, is maintained in the liquid lines during a first duration of time while a beverage is prepared. Later, during a second duration of time while the beverage finishes mixing and is dispensed, however, the pressure is increased to a second, higher level of pressure, which cleans the liquid lines, by blowing out any remaining liquid in the lines.

In these embodiments of the invention, the appliance includes a pressure regulator, which is connected to a controlling microprocessor control unit. The pressure regulator control unit is also connected to one or more flow meters which monitor the volume of liquid flowing through the one or more liquid lines of the appliance and provide this information to the control unit. The pressure regulator is connected to one or more sources of pressurized gas, allowing the pressure regulator to adjust the pressure in the liquid lines. These sources of pressurized gas contain gas having a pressure of about 2 bar above atmospheric pressure to about 4 bar above atmospheric pressure.

In an exemplary embodiment, the pressure regulator control unit maintains the pressure in the one or more liquid lines of the appliance at 2.2 bar during about the first 90% of the duration of the mixing and dispensing time of a beverage. During the final 10% of that duration, however, the pressure regulator control unit instructs the pressure regulator to raise the pressure in the liquid lines to 2.4 bar. One the beverage has been fully dispensed, the pressure regulator then raises the pressure to approximately 3 bar—cleaning all remaining liquid from the liquid lines of the appliance.

### Embodiments Involving a Mixing Chamber

As described above, in embodiments of the present invention where two or more ingredients are mixed with at least one base liquid to form multiple mixed liquids, these mixed liquids must ultimately be combined to produce a beverage to be dispensed. In exemplary embodiments of the present invention, this combination occurs within a component known as a “mixing chamber.”

In certain exemplary embodiments of the present invention, two or more liquid lines of the appliance, each containing base liquid that may be mixed with one or more ingredients, are connected to the mixing chamber. In certain embodiments of the invention, the mixing chamber may contain an electro-mechanical mixing appliance such as a blade or propeller. In certain other embodiments, however, the mixing chamber contains a jet mixer. This jet mixer allows liquids to be mixed together in a short period of time, forming a liquid mixture, emulsion, and/or foam, while ensuring that the end product is mixed with a high degree of homogeneity and smoothness. The jet mixer also avoids exposing the mixture to air, which aids in avoiding premature foaming of a beverage or depressurization of a liquid containing a dissolved gas, such as a carbonated beverage. The mixing chamber includes a jet mixer outlet connecting the mixing chamber to the beverage outlet for dispensing the mixed beverage.

In certain exemplary embodiments of the invention, the jet mixer is a double jet mixer, in which a first liquid line is connected to a first jet discharge end and a second liquid line is connected to a second jet discharge end. However, one of skill in the art would recognize that additional jet discharge ends could be added to the jet mixer in connection with one or more additional liquid lines.

In the above-described double jet mixer, the first and second jet discharge ends expel liquid in mutually opposite or impinging jet streams. The angle of these jet streams can be altered to change the characteristics and functionality of the jet mixer. For example, in one configuration, the angle between the jet discharge ends is 180 degrees, and the jet streams are directly opposite each other (known as a “opposed jet mixer”). In another configuration, the angle between the jet discharge ends is 135 degrees, and the jet streams are impinging jet streams.

In certain exemplary embodiments of the invention, the jet discharge ends are part of the containers in which the ingredients are provided. In these exemplary embodiments, the jet discharge ends are removable from the mixing chamber after the beverage is mixed and dispensed and replaced with new jet discharge ends, ensuring that the mixing chamber remains clean and hygienic and that the next beverage to be mixed is not contaminated with residue/remnants from the previously mixed beverage. In certain exemplary embodiments of the invention, the mixing chamber itself is removable and disposable. In these embodiments, the mixing chamber preferably comprises a plastic material, for example polyethylene or polypropylene.

In other exemplary embodiments of the invention, the mixing chamber is a static mixer, without moving parts, that utilizes turbulence to mix liquids and produce a beverage. The static mixer can be composed of various materials, including stainless steel, polypropylene, Teflon, PDVF, PVC, CPVC, and polyacetal, and can be a plate-type static mixer or a helical-type static mixer. In some embodiments of the invention, the mixing chamber is a disposable plastic mixer chamber which can be disposed and replaced for sanitary reasons.

In certain embodiments of the present invention, the static mixer is a venturi (a constricted, narrow diameter section of a pipe or line, which causes liquid passing through that section to increase in velocity but decrease in pressure—a phenomenon known as the “venturi effect”). As liquid flows through the venturi, the venturi effect creates a vacuum which causes turbulence, causing mixing of the liquid(s) and other ingredients to occur.

In certain embodiments, the mixing chamber is a pressurized chamber. In these embodiments, the pressure in the mixing chamber is maintained between about 0.1 bar and about 1 bar above ambient pressure. In exemplary embodiments, the mixing chamber is connected to a source of pressurized gas via a pressure valve. This source of pressurized gas is maintained at a pressure of between 0.5 and 2 bar higher than the pressure in the mixing chamber itself, and the pressure valve connecting the mixing chamber and the source of gas is controlled by a microprocessor coupled to a temperature sensor in the mixing chamber. When the sensed temperature in the mixing chamber rises above a desired range for preparing a beverage (generally between 2° C. and 5° C.), the microprocessor instructs the pressure valve to open, allowing pressurized gas to enter the mixing chamber and expand, lowering the temperature of the mixing chamber (and of a mixed beverage contained within the mixing chamber).

In certain exemplary embodiments, the mixing chamber includes a cooling element. In some of these embodiments, the cooling element is made up of cooling fins coupled to an electronically-controlled heat exchanger. In these embodiments, the cooling fins are composed of a heat-conducting material and are located inside the mixing chamber. The heat exchanger is located outside the mixing chamber and coupled to the cooling fins, and utilizes, for example, a peltier element or the compression/expansion of gases to discharge heat from the mixing chamber through the cooling fins. One of ordinary skill in the art will recognize that one or more similar cooling elements could be located in other portions of the appliance as well, and used to cool the base liquid(s) and ingredients before and after they are mixed together to form a beverage.

### Embodiments Including a Gas Pressure Regulator

In certain exemplary embodiments of the invention, including the embodiments described above, the appliance for preparing a beverage is capable of regulating the gas pressure in a beverage to be mixed and dispensed. In these exemplary embodiments, the appliance for preparing a beverage includes a source of pressurized gas that is connected to the appliance via a gas ingredient inlet. In certain embodiments, this gas ingredient inlet is coupled to the liquid line of the appliance via a valve in a pressure chamber in the liquid line, the pressure chamber being located downstream of the location where the at least one base liquid and the at least one ingredient are mixed together, but upstream of where the beverage is dispensed from the appliance.

In the above-described embodiments of the invention, the valve in the pressure chamber is controlled by a gas pressure regulation unit. In these embodiments, the gas pressure regulation unit is connected to a sensor element in the liquid line located upstream of the pressure chamber, the sensor element capable of measuring the amount of dissolved and/or entrained gasses in the liquid flowing through the liquid line.

In exemplary embodiments, the sensor element is made up of a first entrained air measurement module assigned to the liquid line, a bleed line, a second entrained air measurement module assigned to the bleed line, and a dissolved air/gas determination microprocessor. The first entrained air measurement module assigned to the liquid line senses and measures entrained air in the liquid line. The bleed line bleeds liquid from the liquid line at a lower pressure and the second entrained air measurement module assigned to the bleed line provides a second measurement of the amount of entrained air in the liquid. The dissolved air/gas determination microprocessor receives these two measurements, determines the amount of dissolved air/gas in the beverage flowing through the liquid line, and provides this measurement to the gas pressure regulation unit.

Depending on the measurement provided by the dissolved air/gas determination microprocessor, the gas pressure regulation unit is configured to release pressurized gas from the gas ingredient inlet into the pressure chamber to be added to the beverage. In certain embodiments, the additional pressurized gas to be added to the beverage is carbon dioxide, nitrogen, nitrogen dioxide, and/or nitrous oxide. In some embodiments, the pressurized gas can be provided from a vessel containing the pressurized gas. In other embodiments, the pressurized gas is generated from a solid or liquid source, for example effervescent or chemical reactants such as food-grade carbonates or acids that are capable of generating carbon dioxide when introduced to water.

In certain embodiments, the pressurized gas may be scented with a flavor such as fermented hops, fruit(s), herb(s), spice(s), confectionaries, mixtures thereof, or other suitable flavors known to those of skill in the art.

In exemplary embodiments, the pressurized gas is injected into the pressure chamber using a jet nozzle which sparges pressurized gas into the liquid in the pressure chamber.

In certain embodiments, the pressurized gas is sparged in a direction opposite the direction the beverage is flowing in the pressure chamber. Sparging is a technique in which a chemically inert gas is bubbled through a liquid. This technique allows the gas pressure of the beverage to be raised to a desired level.

### EXAMPLES

The following prophetic examples describe potential embodiments of the present invention:

Example 1: A base liquid beer that has an alcohol concentration of between 6 and 8 alcohol by volume (ABV) and a temperature of 5° C. is mixed with the contents of a concentrated ingredient pod that contains 5 grams of hop concentrates and fruit concentrates to form a 12 ounce beverage. Carbon dioxide is dissolved within the beverage, and the beverage is chilled to below 0° C. and dispensed into a glass.

Example 2: A carbonated base liquid lager that is concentrated to three times the sugar content of the high-gravity beer from which it was concentrated, and having an alcohol concentration of between 10 and 12 alcohol by volume (ABV) and a temperature of 5° C., is mixed with the contents of an ingredient pod that contains 10 grams of spice and fruit flavor ingredients to form a beverage. Carbonated water is added to the beverage to form a 20 ounce beverage, and the beverage is chilled to about 2.5° C. and dispensed into a glass.

Example 3: A hypercarbonated base liquid ale that is concentrated to two times the sugar content of the high-gravity beer from which it was concentrated, and having an alcohol concentration of between 8 and 10 alcohol by volume (ABV) and a temperature of 2.5° C., is mixed with the contents of a concentrated ingredient pod that contains 8 grams of hop concentrates and a foaming promoter. Hypercarbonated water is added to the beverage to form a 16 ounce beverage, and the beverage is chilled to a temperature of below 0° C. and dispensed into a glass.

Example 4: A base liquid beer that has an alcohol concentration of between 2 and 4 alcohol by volume (ABV) and a temperature of below 0° C. is mixed with the contents of a concentrated ingredient pod containing 12 grams of an alcoholic, carbonated beer concentrate to produce a beverage. The alcohol in the concentrated ingredient pod raises the alcohol content of the beverage to between 6 and 8 ABV. Carbon dioxide is dissolved in the beverage to form a carbonated beverage, which is dispensed at a temperature of about 2.5° C.

Embodiments and prophetic examples of the present invention have been described for the purpose of illustration. Persons skilled in the art will recognize from this description that the described embodiments and prophetic examples are not limiting, and may be practiced with modifications and alterations limited only by the spirit and scope of the appended claims which are intended to cover such modifications and alterations, so as to afford broad protection to the various embodiments of the invention and their equivalents.

What is claimed is:

1. A method of preparing a beverage, comprising the steps of:
selecting at least one base liquid;
selecting at least one ingredient;
mixing the at least one base liquid with the at least one ingredient to produce a beverage; and
dispensing the beverage.

2. The method of claim 1, wherein the at least one base liquid is selected from the group consisting of beers, ciders, wines, malt-based beverages, fermented beverages, cider-based beverages, and spirits.

3. The method of claim 1, wherein the at least one base liquid is concentrated.

4. The method of claim 1, wherein the at least one base liquid is pressurized.

5. The method of claim 4, wherein the pressurized base liquid contains a dissolved gas.

6. The method of claim 5, wherein the dissolved gas is carbon dioxide, nitrogen, or nitrogen dioxide.

7. The method of claim 6, wherein the pressurized base liquid has a gas pressure of at least 0.5 bar above atmospheric pressure at 2° C.

8. The method of claim 1, wherein the step of selecting at least one base liquid comprises selecting a first base liquid and selecting a second base liquid.

9. The method of claim 8, wherein the second base liquid is selected from the group consisting of beers, juices, syrups, carbonated waters, carbonated soft drinks, alcohols, coffees, teas, milk, and plant extracts.

10. The method of claim 8, wherein the step of selecting at least one ingredient comprises selecting a first ingredient and a second ingredient, and the step of mixing comprises mixing the first base liquid with the first ingredient to produce a first mixed liquid and mixing the second base liquid with the second ingredient to produce a second mixed liquid.

11. The method of claim 10, further comprising the step of jet mixing the first mixed liquid with the second mixed liquid to produce the beverage.

12. The method of claim 1, wherein the at least one base liquid is dispensed from a container selected from the group consisting of a keg, a bag, a bag-in-bottle, a-bag-in-box, a bottle, a can, and a cask.

13. The method of claim 12, wherein the base liquid is dispensed from the container using pressurized gas or a pump.

14. The method of claim 1, wherein the at least one ingredient is a flavor ingredient selected from the group consisting of a spice flavor, a fruit flavor, a hop flavor, a malt flavor, a nut flavor, a smoke flavor, a coffee flavor, a chocolate flavor, and mixtures thereof.

15. The method of claim 1, wherein the at least one ingredient is a solid or liquid concentrated ingredient selected from the group consisting of hop concentrates, fruit concentrates, sweeteners, bittering additives, concentrated spices, foaming promoters, concentrated malt-based liquids, concentrated fermented liquids, concentrated beer, colorants, alcohols, flavoring additives, and mixtures thereof.

16. The method of claim 1, wherein the step of selecting at least one ingredient comprises selecting a first ingredient and a second ingredient, and the step of mixing comprises mixing the at least one base liquid with the first ingredient to produce a first mixed liquid and mixing the at least one base liquid with the second ingredient to produce a second mixed liquid.

17. The method of claim 16, further comprising the step of jet mixing the first mixed liquid with the second mixed liquid to produce the beverage.

18. The method of claim 17, wherein the second mixed liquid contains a foaming promoter.

19. The method of claim 1, wherein the step of mixing the at least one base liquid with the at least one ingredient is performed in a disposable container.

20. The method of claim 1, further comprising the step of expanding a pressurized gas to cool the beverage prior to dispensing the beverage.

21. The method of claim 1, wherein the liquid pressure on the at least one base liquid and the beverage are increased during the steps of mixing the at least one base liquid with the at least one ingredient and dispensing the beverage.

22. The method of claim 21, further comprising the step of increasing the pressure after the beverage is dispensed to at least 3 bar above atmospheric pressure.

23. The method of claim 1, further comprising the step of adding pressurized gas to the beverage prior to dispensing the beverage.

24. The method of claim 23, wherein the pressurized gas is carbon dioxide, nitrogen, or nitrogen dioxide.

25. The method of claim 24, wherein the pressurized gas is scented with a flavor selected from the group consisting of fermented hops, a fruit, a herb, a spice, a confectionary, or a mixture thereof.

26. An appliance for preparing a beverage, comprising:
a first liquid inlet for intake of a first base liquid;
a first receptacle for intake of a first ingredient container;
a beverage outlet to dispense a mixed beverage; and
a first liquid line to transport liquid from the first liquid inlet to the beverage outlet.

27. The appliance of claim 26, further comprising a second receptacle for intake of a second ingredient container.

28. The appliance of claim 27, wherein the first liquid line is split into a first side line connecting the first liquid inlet to the first receptacle and a second side line connecting the first liquid inlet to the second receptacle.

29. The appliance of claim 28, wherein the first side line connects the first receptacle to the second receptacle.

30. The appliance of claim 28, further comprising a microprocessor configured to control a valve capable of varying the flow rate in each of the first side line and the second side line.

31. The appliance of claim 30, further comprising a scanner configured to identify the contents of each of the first ingredient container and the second ingredient container.

32. The appliance of claim 31, wherein the scanner is coupled to the microprocessor, and the flow rate in each of the first side line and the second side line varies based on the identity of the contents of each of the first ingredient container and the second ingredient container.

33. The appliance of claim 27, further comprising a second liquid inlet for intake of a second base liquid; and
a second liquid line to transport liquid from the second liquid inlet to the beverage outlet.

34. The appliance of claim 33, wherein the first liquid line and the second liquid line are connected to a mixing chamber.

35. The appliance of claim 34, wherein the mixing chamber comprises a double jet mixer, the first liquid line is connected to a first jet mixer discharge end, the second liquid line is connected to a second jet mixer discharge end, and the mixing chamber is connected to the beverage outlet via a jet mixer outlet.

36. The appliance of claim 35, wherein the double jet mixer is an opposed jet mixer where the first jet mixer discharge end is at a 180 degree angle to the second jet mixer discharge end.

37. The appliance of claim 35, wherein the double jet mixer is an impinging jet mixer where the first jet mixer discharge end is at a 135 degree angle to the second jet mixer discharge end.

38. The appliance of claim 34, wherein the mixing chamber is directly connected to the first receptacle and to the second receptacle.

39. The appliance of claim 26, wherein the first liquid line is connected to a mixing chamber.

40. The appliance of claim 39, wherein the mixing chamber is disposable and comprised of a plastic material.

41. The appliance of claim 39, further comprising a temperature sensor configured to measure the temperature in the mixing chamber; and
a microprocessor connected to the temperature sensor and configured to control the temperature in the mixing chamber based on the measured temperature in the mixing chamber.

42. The appliance of claim 41, wherein the mixing chamber comprises a pressurized fluid inlet, and the pressurized fluid inlet is connected to a source of pressurized fluid.

43. The appliance of claim 42, wherein the microprocessor controls the temperature in the mixing chamber by releasing pressurized fluid into the mixing chamber to lower the temperature in the mixing chamber.

44. The appliance of claim 39, wherein the mixing chamber further comprises cooling fins extending within the mixing chamber, the cooling fins coupled to a heat exchanger configured to remove heat from the cooling fins and out of the mixing chamber.

45. The appliance of claim 26, further comprising a pressure regulator configured to control the pressure in the first liquid line.

46. The appliance of claim 45, wherein the pressure regulator is configured to maintain the pressure in the first liquid line at a first pressure level during the dispensing of a mixed beverage, and to raise the pressure in the first liquid line to a higher second pressure level once the mixed beverage has been fully dispensed.

47. The appliance of claim 26, further comprising:
a gas ingredient inlet for intake of a first pressurized gas;
a pressure chamber within the first liquid line;
wherein the pressure chamber is downstream of the first receptacle and upstream of the beverage outlet, and the pressure chamber is connected to the gas ingredient inlet.

48. The appliance of claim 47, further comprising a measuring appliance configured to measure the amount of dissolved and/or entrained gasses in a mixed beverage, wherein the measuring appliance is located upstream of the pressure chamber.

49. The appliance of claim 48, further comprising a jet nozzle in the pressure chamber coupled to the gas ingredient inlet; and
a microprocessor connected to the measuring appliance,
wherein the microprocessor is configured, dependent on the amount of dissolved and/or entrained gasses measured by the measuring appliance, to allow the jet nozzle to sparge pressurized gas in the pressure chamber to raise the gas pressure level in the mixed beverage.

50. The appliance of claim 48, wherein the measuring appliance comprises an entrained air measurement module and a dissolved air/gas measurement module.

51. A system for preparing a beverage, comprising:
a base liquid source containing at least one base liquid;
an ingredient source containing at least one ingredient;
a mixer for mixing the at least one base liquid with the at least one ingredient to produce a beverage; and
a dispenser for dispensing the beverage produced from the base liquid and the at least one ingredient.

52. The system of claim 51, further comprising:
a carbonator for carbonating the beverage produced from the base liquid and the at least one ingredient.

53. The system of claim 51, further comprising:
a cooling element for lowering the temperature of the beverage produced from the base liquid and the at least one ingredient.
